(19) United States
(12) Patent Application Publication
(10) Pub. No.: US 2014/0366020 A1
(43) Pub. Date: Dec. 11, 2014

(54) SYSTEM AND METHOD FOR MANAGING VIRTUAL MACHINE STOCK

(71) Applicant: HON HAI PRECISION INDUSTRY CO., LTD., New Taipei (TW)

(72) Inventors: CHUNG-I LEE, New Taipei (TW); KUAN-CHIAO PENG, New Taipei (TW); HO-I SUN, New Taipei (TW)

(73) Assignee: HON HAI PRECISION INDUSTRY CO., LTD., New Taipei (TW)

(21) Appl. No.: 14/092,902

(22) Filed: Nov. 27, 2013

(30) Foreign Application Priority Data
Jun. 6, 2013 (TW) 102120021

(51) Int. Cl. G06F 9/455

(52) U.S. Cl. CPC G06F 9/45533
USPC 718/1

(57) ABSTRACT

A cloud server sets upper stock limits, lower stock limits, and stocks for virtual machines (VMs) having different configuration specifications in the cloud server. When the VM stock of the VMs having the configuration specification is greater than a corresponding lower stock limit of the VMs, the cloud server calculates a supplement of the VMs having one configuration specification according to the corresponding stock and the upper stock limit of the VMs having the configuration specification. The cloud server further configures the number of the supplement of the VMs having the configuration specification in the cloud server.

### BACKGROUND

1. Technical Field

Embodiments of the present disclosure relate to cloud computing technology, and more particularly to a system and method for managing a virtual machine stock.

2. Description of related art

Virtual machines (VMs) are software implementations that create one or more VMs on an operating system (OS) of a server. A cloud server can provide VMs to a client device according to configuration specifications (e.g., specifications of the OS, central processing unit, memory, and hard disk resources) of the desired VMs requested by the client device. In order to make users use the VMs immediately, one method is to pre-establish an available number of VMs (referred as a VM stock) for each kind of VMs. When the VM stock of a first kind of VMs is less than a stock threshold of the VMs, the first kind of VMs is configured to complement the VM stock of the first kind of VMs. However, in the method, number of the VMs may be frequently insufficient, causing the VM stock to be diminished. Furthermore, improperly setting of the number of the VM stock may cause waste of resources. Thus, the VMs cannot be managed automatically and efficiently.

### BRIEF DESCRIPTION OF THE DRAWINGS

FIG. 1 is a block diagram of one embodiment of an application environment of a cloud server including a virtual machine (VM) stock management system.

FIG. 2 is a block diagram of one embodiment of function modules of the VM stock management system in FIG. 1.

FIG. 3 is a flowchart of one embodiment of a method for managing a VM stock.

FIG. 4 is a schematic diagram illustrating one embodiment of an initial record of VMs having different configuration specifications.

FIG. 5 is a schematic diagram illustrating one embodiment of a use record of VMs having different configuration specifications.

FIG. 6 is a schematic diagram illustrating one embodiment of adjusting the record of the VMs having different configuration specifications.

FIG. 7 is a flowchart of one embodiment of a method of adjusting a upper stock limit and a lower stock limit of the VMs.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

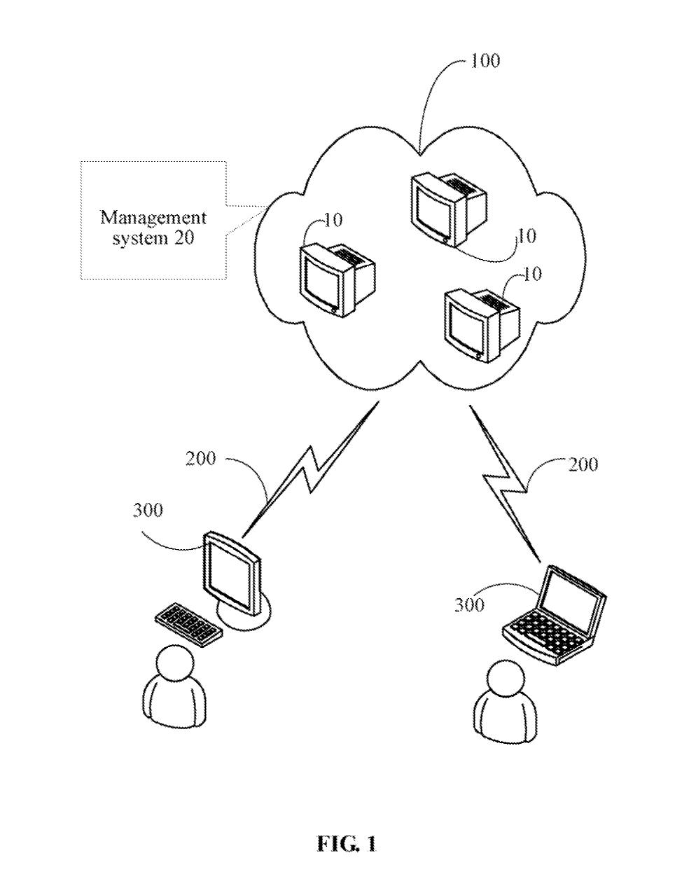

FIG. 1 is a block diagram of one embodiment of an application environment of a cloud server 100 using a virtual machine (VM) stock management system 20 (hereinafter referred to as “the management system 20”). The cloud server 100 may be a single server or a server cluster including a plurality of servers. One or more client devices 300 (e.g. two personal computers are shown) are connected to the cloud server 100 via a network 200. The cloud server 100 stores a number of VMs 10 having different configuration specifications and assigns one or more required VMs 10 to a client device 300 upon receiving a request from the client device 300. The management system 20 presets a upper stock limit and a lower stock limit of the VMs 10 of each kind of configuration specification and adjusts the upper stock limit and the lower stock limit automatically according to a usage amount and an available number of the VMs 10.

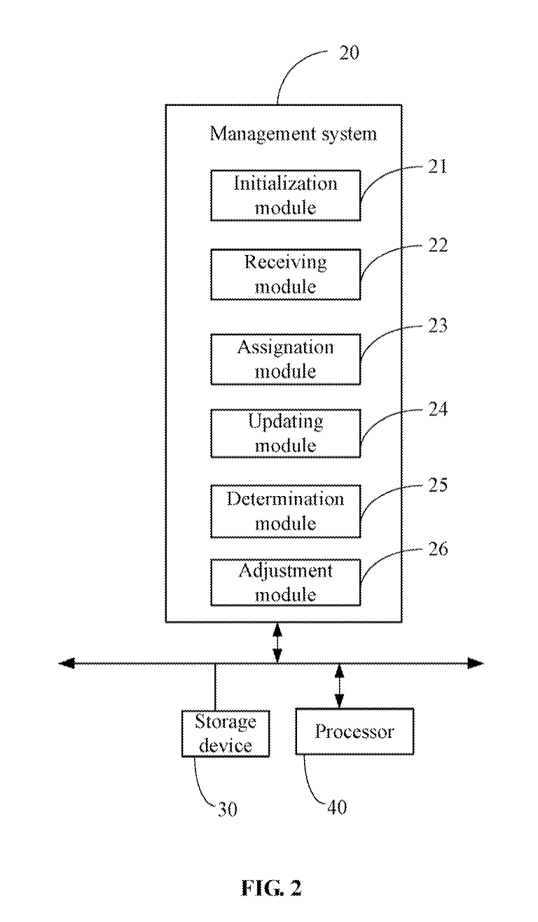

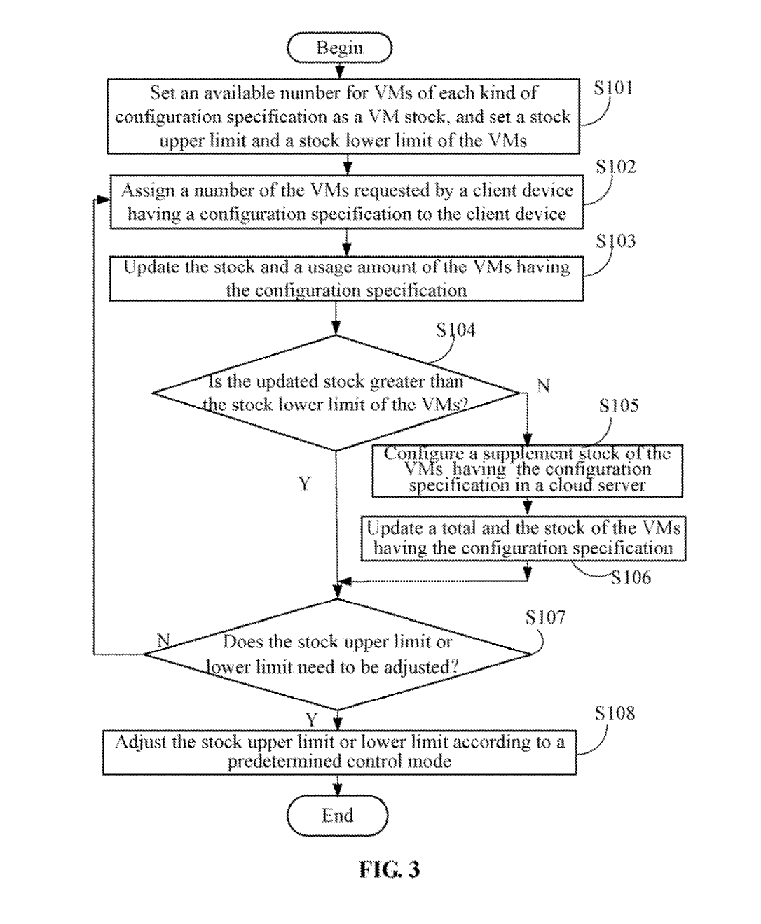

As shown in FIG. 2, the management system 20 includes a plurality of function modules, such as an initialization module 21, a receiving module 22, an assignation module 23, an updating module 24, a determination module 25, and an adjustment module 26. The modules 21-26 include computerized code in the form of one or more programs that are stored in a non-transitory storage device 30 of the cloud server 100. The storage device 30 is a dedicated memory, such as an EPROM, a hard disk driver (HDD), or flash memory. The computerized code includes instructions that are executed by at least one processor 40 of the cloud server 100 to provide aforementioned functions of the management system 20. Detailed descriptions of the functions of the modules 21-26 are given below with reference to FIG. 3-FIG. 7.

FIG. 3 is a flowchart of one embodiment of a method for managing a VM stock. Depending on the embodiment, additional steps may be added, others removed, and the ordering of the steps may be changed.

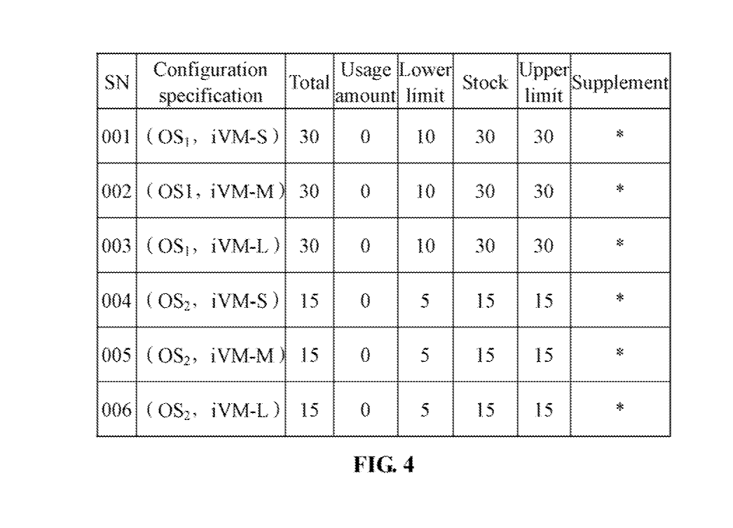

In step S101, the initialization module 21 initially sets VM stocks, upper stock limits and lower stock limit for VMs 10 having different configuration specifications in the server 1. The configuration specifications represent, but are not limited to, different specifications of OS, CPU, memory, and hard disk resources. As shown in FIG. 4, the cloud server 100 may provide multiple VMs 10 having six different configuration specifications. For example, a configuration specification of “(OS₁, iVM-S)” numbered “001” represents that the VM 10 includes one CPU, a 2G memory, and a 100 G hard disk. In one embodiment, the VM stock of the VMs of one configuration specification is initialized to be equal to the upper stock limit of the VMs 10 of the configuration specification.

The VM stock indicates an available number of VMs 10 having the configuration specification configured by the cloud server 100 and not assigned to the client devices 300. The upper stock limit indicates a maximum number of the VMs 10 having the configuration specification that can be requested by the client devices 300. The lower stock limit indicates a minimum number of the VMs 10 having the configuration specification which should be kept in the cloud server 100. If the VM stock is less than the lower stock limit of the VMs 10 having one configuration specification, the cloud server 100 configures more VMs 10 having the configuration specification to complement the VM stock of the VMs 10. In one embodiment, the upper stock limits, the lower stock limits and the VM stock of the VMs 10 may be modified according to configuration experiences and actual requirements in different situations.

As shown in FIG. 4, “Total” represents a total number of VMs 10 which is equal to a summation of “Usage amount” and “Stock”, and the “Usage amount” represents that a number of VMs 10 having a configuration specification which have been requested and assigned to the client devices 300. “Supplement” is equal to a difference between “Upper limit” and “Stock”. “Supplement” represents a supplement stock of VMs 10 having one configuration specification which needs to be configured by the cloud server 100, when the VM stock is less than or equal to the lower stock limit of the VMs 10 having the configuration specification.

In step S102, the receiving module 22 receives a request for configuring one or more VMs 10 from a client device 300, determines a configuration specification and a number of the VMs 10 requested by the client device 300 according to the request, and the assignation module 23 assigns the determined number of VMs 10 having the determined configuration specification to the client device 300. For example, the client device 300 may requests four VMs 10 having the configuration specification of “(OS₂, iVM-M).”

In step S103, the updating module 24 updates the VM stock and a usage amount of the VMs 10 having the determined configuration specification. The updating module 24 updates the VM stock by subtracting the determined number from the VM stock of the VMs 10 having the determined configuration specification. The updating module 24 updates the usage amount by adding the determined number to a previous usage amount of the VMs 10 having the determined configuration specification.

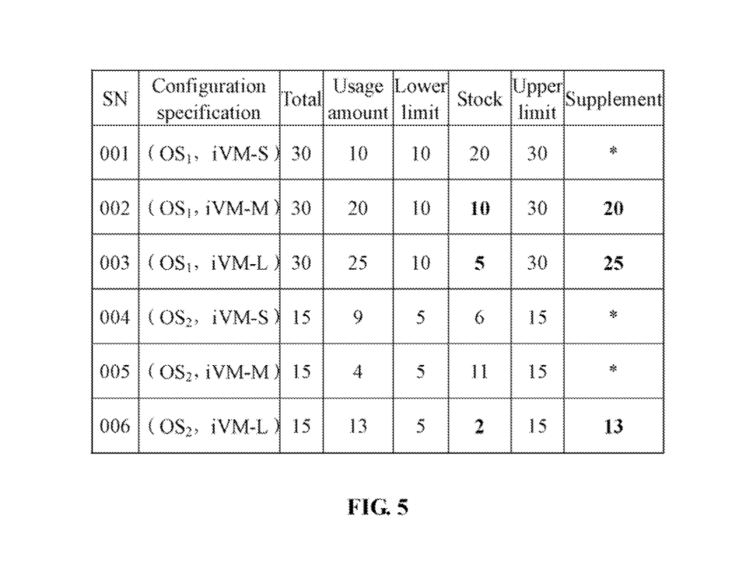

In step S104, the determination module 25 determines whether the updated stock is greater than a lower stock limit of the VMs 10 having the determined configuration specification. If the updated stock is less than or equal to the lower stock limit, step S105 is implemented. Otherwise, if the updated stock is greater than a lower stock limit, step S107 is implemented. For example, as shown in FIG. 5, the VM stocks of the VMs 10 having the configuration specifications numbered “002”, “003” and “006” are less than or equal to corresponding lower stock limits, so step S105 is implemented. The VM stocks of the VMs 10 having the configuration specifications numbered “001,” “004,” and “005” are greater than corresponding lower stock limits, so step S107 is implemented.

In step S105, the generation module 26 calculates a supplement stock of the VMs 10 having the determined configuration specification, and configures a supplement number of the VMs 10 having the determined configuration specification according to the supplement stock in the cloud server 100. In one embodiment, the generation module 26 obtains the supplement stock by calculating a difference between the upper stock limit and the VM stock of the VMs 10 having the determined configuration specification. For example, as shown in FIG. 5, a supplement stock of the VMs 10 having the configuration specification numbered with “002” is “20,” a supplement stock of VMs 10 numbered with “003” is “25,” and a supplement stock of VMs 10 numbered with “006” is “13.” The generation module 26 configures the corresponding supplement numbers of VMs 10 in the cloud server 100 according to the supplement stocks.

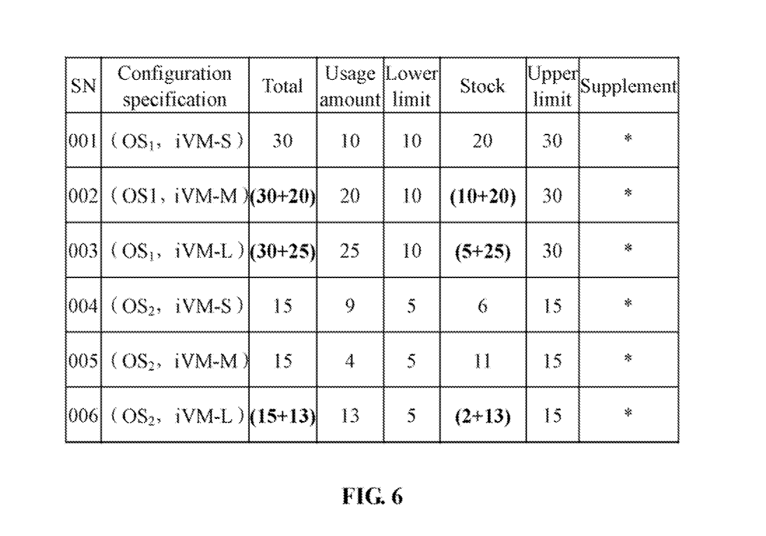

In step S106, the updating module 24 further updates a total number and the VM stock of the VMs 10 having the determined configuration specification. As shown in FIG. 6, the total number and the VM stock of the VMs 10 having the configuration specifications numbered with “002” are added the supplement number of “20” respectively. In one embodiment, when the client device 300 deletes a number of the requested VMs 10 permanently, that is, deletes data completely and release occupation hardware resources, the updating module 24 updates the total number and the VM stock of the requested VMs 10 by decreasing the number of the requested VMs 10. The total number of the VMs 10 is increased with an increase number of the VM stock, and is decreased with a decrease number of the usage amount.

In step S107, the determination module 25 determines whether the upper stock limit or the lower stock limit of the VMs 10 having the determined configuration specification is required to be adjusted according to a predetermined control mode. If the upper stock limit or the lower stock limit is required to be adjusted, step S108 is implemented. If the upper stock limit and the lower stock limit are not required be adjusted, step S102 is repeated. In one embodiment, the predetermined control modes may include, but are not limited to, a time cycle calculation method, a usage ratio method, a moving average method, a history recording method and a manual controlling method.

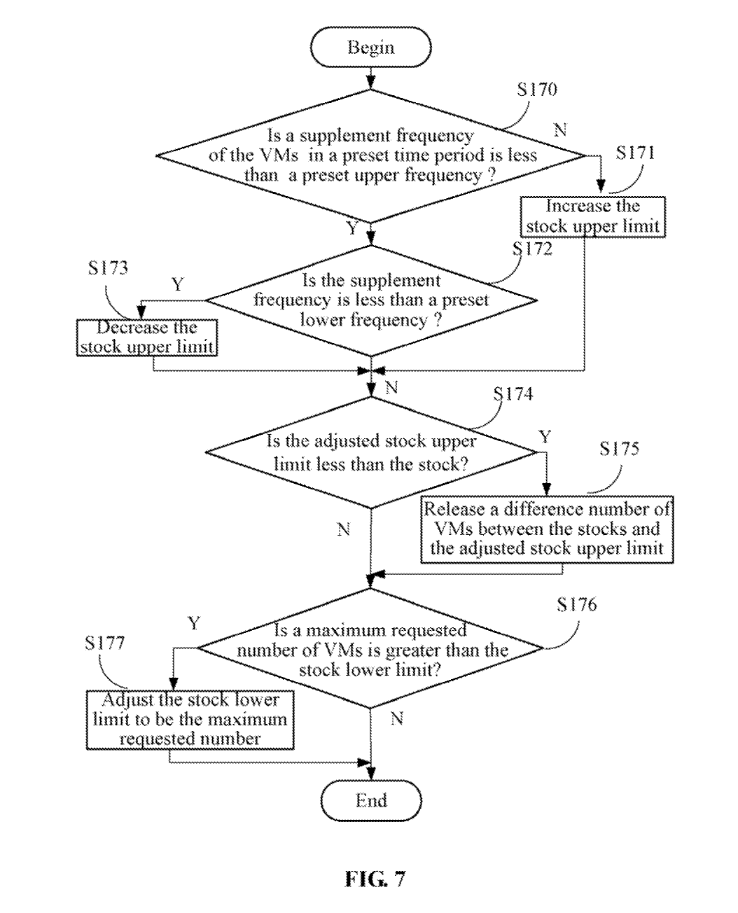

The time cycle calculation method (hereinafter referred to as “calculation method”) determines whether or not a supplement frequency of the VMs 10 having the determined configuration specification during a preset time period is greater than or equal to a preset upper frequency. The supplement frequency represents a frequency of the client devices 300 requesting the VMs 10. If the supplement frequency is greater than or equal to the preset upper frequency, the calculation method adjusts the upper stock limit of the VMs 10 by a preset increase number. If the supplement frequency is less than a preset lower frequency, the calculation method adjusts the upper stock limit by a preset decrease number. If the upper stock limit is decreased to be less than the VM stock, a redundant number of VMs 10 between the VM stock and the adjusted upper stock limit may be released and deleted from the VM stock in the cloud server 100. If a maximum requested number of the VMs 10 by the client devices 300 during the preset time period is greater than the lower stock limit, the calculation method adjusts the lower stock limit to be equal to the maximum requested number. Details of the calculation method are described in FIG. 7.

The usage ratio method presets a first ratio and a second ratio. If a proportion between the upper stock limit and the usage amount of the VMs 10 having the determined configuration specification is less than the first ratio, the usage ratio method adjusts the upper stock limit to be equal to a product of the usage amount and the first ratio. If a proportion between the lower stock limit and the usage amount is greater than the second ratio, the usage ratio method adjusts the lower stock limit to be equal to a product of the usage amount and the second ratio.

The moving average method calculates a future requirement number according to recent usage data of the VMs 10 having the determined configuration specification. The moving average method may record each time a requested number of the VMs 10 by the client devices 300, and calculates an average requested number according to a simple moving average (SMA) method as the future requested number. The future requested number equals (R₍ₜ₋₁₎+R₍ₜ₋₂₎+ . . . +R₍ₜ₋ₙ₎)/n, where “n” represents a frequency of requesting the VMs 10, and R₍ₜ₋ₙ₎ represents a number of requests for VMs 10 a previous “n” times. In other embodiments, the moving average method may calculate the future requested number according to a weighted moving average (WMA) method. The WMA method assigns different weight numbers to each requested number. For example, the latest requested number has a weight number n, and the second latest requested number has a weight number n−1. The WMA calculates the future requested number according to the formula (n*R₍ₜ₋₁₎+(n−1)*R₍ₜ₋₂₎+ . . . +1*R₍ₜ₋ₙ₎)/(n+n−1+ . . . 1). The moving average method adjusts the upper stock limit or the lower stock limit according to the future requested number and a preset ratio.

The history recording method adjusts the upper stock limit and the lower stock limit by calculating an average upper limit and an average lower limit of history upper stock limits and history lower stock limits over a predetermined time period, such as a quarter of last year.

The manual controlling method adjusts the upper stock limit and the lower stock limit according to manual adjustments of a history upper stock limit and a history lower stock limit over the predetermined time period.

In step S108, the adjustment module 26 adjusts the upper stock limit or the lower stock limit of the VMs 10 having the determined configuration specification according to the predetermined control mode.

FIG. 7 is a flowchart of one embodiment of a calculation method of adjusting a upper stock limit and a lower stock limit of the VMs 10. Depending on the embodiment, additional steps may be added, others removed, and the ordering of the steps may be changed.

In step S170, the determination module 25 determines whether or not a supplement frequency of the VMs 10 having the determined configuration specification during a preset time period is less than a preset upper frequency (e.g. 5). The supplement frequency represents a request frequency of the VMs 10 by the client device 300. If the supplement frequency is greater than or equal to the preset upper frequency, step S171 is implemented. Otherwise, if the supplement frequency is less than the preset upper frequency, step S172 is implemented.

In step S171, the adjustment module 26 adjusts the upper stock limit of the VMs 10 by a preset increase number, and step 174 is implemented.

In step S172, the determination module 25 determines whether or not the supplement frequency in the preset time period is less than a preset lower frequency (e.g. 1). If the supplement frequency is less than the preset lower frequency, step S173 is implemented. Otherwise, if the supplement frequency is greater than or equal to the preset lower frequency, step S174 is implemented.

In step S173, the adjustment module 26 adjusts the upper stock limit by a preset decrease number.

In step S174, the determination module 25 determines whether or not the adjusted upper stock limit is less than the VM stock of the VMs 10 having the determined configuration specification. If the adjusted upper stock limit is less than the VM stock, step S175 is implemented. Otherwise, if the adjusted upper stock limit is greater than or equal to the VM stock, step S176 is implemented.

In step S175, the adjustment module 26 releases a redundant number of the VMs 10 having the determined configuration specification by calculating a difference between the VM stock and the adjusted upper stock limit, and deletes the redundant number of the VMs 10 in the cloud server 100.

In step S176, the determination module 25 determines whether or not a maximum requested number of the VMs 10 by the client devices 300 during the preset time period is greater than the lower stock limit. If the maximum requested number is greater than the lower stock limit, step S177 is implemented. Otherwise, if the maximum requested number is less than or equal to the lower stock limit, the lower stock limit is maintained and the procedure ends.

In step S177, the adjustment module 26 adjusts the lower stock limit to be equal to the maximum requested number.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method being executed by a processor of a server, the method comprising:
setting virtual machine (VM) stocks, upper stock limits and lower stock limit for VMs having different configuration specifications in the server, the VM stock representing an available number of the VMs;
calculating a supplement stock of VMs having a specified configuration specification according to a difference between a VM stock and a upper stock limit of the VMs having the specified configuration specification, when the VM stock is greater than a corresponding lower stock limit of the VMs having the specified configuration specification; and
configuring a supplement number of VMs having the specified configuration specification in the cloud server according to the supplement stock.

2. The method of claim 1, further comprising:
receiving a request for configuring a number of the VMs having the specified configuration specification from a client device; and
assigning the number of the VMs having the specified configuration specification to the client device.

3. The method of claim 2, further comprising:
determining whether the upper stock limit or the lower stock limit of the VMs having the specific configuration specification needs to be adjusted according to a predetermined control mode; and
adjusting the upper stock limit or the lower stock limit of the VMs having the specific configuration specification according to the predetermined control mode, when the upper stock limit or the lower stock limit is determined to be adjusted.

4. The method of claim 3, further comprising:
determining whether a supplement frequency of the VMs having the specific configuration specification during a preset time period is greater than or equal to a preset upper frequency or less than a preset lower frequency, the supplement frequency representing request frequencies of the VMs by the client device;
adjusting the upper stock limit of the VMs by a preset increase number when the supplement frequency is greater than or equal to the preset upper frequency, or adjusting the upper stock limit by a preset decrease number when the supplement frequency is less than the preset lower frequency;
releasing a redundant number of the VMs having the specific configuration specification by calculating a difference between the VM stock and the adjusted upper stock limit, and deleting the redundant number of the VMs in the cloud server, when the adjusted upper stock limit is less than the VM stock of the VMs; and
adjusting the lower stock limit to be equal to a maximum requested number of the VMs having the specific configuration specification received from the client device, when the maximum requested number during the preset time period is greater than the lower stock limit.

5. The method of claim 2, further comprising:
updating the VM stock and a usage amount of the VMs having the specific configuration specification after assigning the number of VMs having the specific configuration specification to the client device; and
updating a total number and the VM stock of the VMs having the specific configuration specification after configuring the number of the VMs having the specific configuration specification in the cloud server.

6. The method of claim 5, wherein the total number of the VMs having the specific configuration specification is equal to a summation of the usage amount and the VM stock of the VMs, and the usage amount represents that a number of VMs having the specific configuration specification which have been requested and assigned to the client devices.

7. A cloud server, comprising:
at least one processor; and
a storage device storing one or more programs, when executed by the at least one processor, cause the at least one processor to perform operations of:
setting virtual machine (VM) stocks, upper stock limits and lower stock limit for VMs having different configuration specifications in the server, the VM stock representing an available number of the VMs;
calculating a supplement stock of VMs having a specified configuration specification according to a difference between a VM stock and a upper stock limit of the VMs having the specified configuration specification, when the VM stock is greater than a corresponding lower stock limit of the VMs having the specified configuration specification; and
configuring a supplement number of VMs having the specified configuration specification in the cloud server according to the supplement stock.

8. The cloud server of claim 7, wherein the operations further comprise:
receiving a request for configuring a number of the VMs having the specified configuration specification from a client device; and
assigning the number of the VMs having the specified configuration specification to the client device.

9. The cloud server of claim 8, wherein the operations further comprise:
determining whether the upper stock limit or the lower stock limit of the VMs having the specific configuration specification needs to be adjusted according to a predetermined control mode; and
adjusting the upper stock limit or the lower stock limit of the VMs having the specific configuration specification according to the predetermined control mode, when the upper stock limit or the lower stock limit is determined to be adjusted.

10. The cloud server of claim 9, wherein the operations further comprise:
determining whether a supplement frequency of the VMs having the specific configuration specification during a preset time period is greater than or equal to a preset upper frequency or less than a preset lower frequency, the supplement frequency representing request frequencies of the VMs by the client device;
adjusting the upper stock limit of the VMs by a preset increase number when the supplement frequency is greater than or equal to the preset upper frequency, or adjusting the upper stock limit by a preset decrease number when the supplement frequency is less than the preset lower frequency;
releasing a redundant number of the VMs having the specific configuration specification by calculating a difference between the VM stock and the adjusted upper stock limit, and deleting the redundant number of the VMs in the cloud server, when the adjusted upper stock limit is less than the VM stock of the VMs; and
adjusting the lower stock limit to be equal to a maximum requested number of the VMs having the specific configuration specification received from the client device, when the maximum requested number during the preset time period is greater than the lower stock limit.

11. The cloud server of claim 8, wherein the operations further comprise:
updating the VM stock and a usage amount of the VMs having the specific configuration specification after assigning the number of VMs having the specific configuration specification to the client device; and
updating a total number and the VM stock of the VMs having the specific configuration specification after configuring the number of the VMs having the specific configuration specification in the cloud server.

12. The cloud server of claim 11, wherein the total number of the VMs having the specific configuration specification is equal to a summation of the usage amount and the VM stock of the VMs, and the usage amount represents that a number of VMs having the specific configuration specification which have been requested and assigned to the client devices.

13. A non-transitory computer-readable medium having stored thereon instructions that, when executed by at least one processor of a cloud server, cause the at least one processor to perform operations of:
setting virtual machine (VM) stocks, upper stock limits and lower stock limit for VMs having different configuration specifications in the server, the VM stock representing an available number of the VMs;
calculating a supplement stock of VMs having a specified configuration specification according to a difference between a VM stock and a upper stock limit of the VMs having the specified configuration specification, when the VM stock is greater than a corresponding lower stock limit of the VMs having the specified configuration specification; and
configuring a supplement number of VMs having the specified configuration specification in the cloud server according to the supplement stock.

14. The medium of claim 13, wherein the operations further comprise:
receiving a request for configuring a number of the VMs having the specified configuration specification from a client device; and
assigning the number of the VMs having the specified configuration specification to the client device.

15. The medium of claim 14, wherein the operations further comprise:
determining whether the upper stock limit or the lower stock limit of the VMs having the specific configuration specification needs to be adjusted according to a predetermined control mode; and
adjusting the upper stock limit or the lower stock limit of the VMs having the specific configuration specification according to the predetermined control mode, when the upper stock limit or the lower stock limit is determined to be adjusted.

16. The medium of claim 15, wherein the operations further comprise:
determining whether a supplement frequency of the VMs having the specific configuration specification during a preset time period is greater than or equal to a preset upper frequency or less than a preset lower frequency, the supplement frequency representing request frequencies of the VMs by the client device;
adjusting the upper stock limit of the VMs by a preset increase number when the supplement frequency is greater than or equal to the preset upper frequency, or adjusting the upper stock limit by a preset decrease number when the supplement frequency is less than the preset lower frequency;
releasing a redundant number of the VMs having the specific configuration specification by calculating a difference between the VM stock and the adjusted upper stock limit, and deleting the redundant number of the VMs in the cloud server, when the adjusted upper stock limit is less than the VM stock of the VMs; and
adjusting the lower stock limit to be equal to a maximum requested number of the VMs having the specific configuration specification received from the client device, when the maximum requested number during the preset time period is greater than the lower stock limit.

17. The medium of claim 14, wherein the operations further comprise:
updating the VM stock and a usage amount of the VMs having the specific configuration specification after assigning the number of VMs having the specific configuration specification to the client device; and
updating a total number and the VM stock of the VMs having the specific configuration specification after configuring the number of the VMs having the specific configuration specification in the cloud server.

18. The medium of claim 17, wherein the total number of the VMs having the specific configuration specification is equal to a summation of the usage amount and the VM stock of the VMs, and the usage amount represents that a number of VMs having the specific configuration specification which have been requested and assigned to the client devices.
